(19) United States
(12) Patent Application Publication
(10) Pub. No.: US 2026/0321842 A1
(43) Pub. Date: Oct. 15, 2026

(54) A BATTERY ASSEMBLY

(71) Applicant: Dyson Technology Limited, Malmesbury, Wiltshire (GB)

(72) Inventors: Sean CREED, Chippenham (GB); Steven GOLD, Malmesbury, Wiltshire (GB); Ali AL-RUBEI, Swindon (GB); Shubham KUMAR, Bristol (GB)

(21) Appl. No.: 19/486,146

(22) PCT Filed: May 14, 2024
(86) PCT No.: PCT/IB2024/054664

§ 371 Date: Nov. 20, 2025

(30) Foreign Application Priority Data
May 26, 2023 (GB) 2307908.0

(51) Int. Cl. H01M 50/242; H01M 10/04; H01M 10/48; H01M 50/211; H01M 50/293

(52) U.S. Cl. CPC H01M 50/242; H01M 10/0481; H01M 10/482; H01M 10/486; H01M 50/211; H01M 50/293

(57) ABSTRACT

A battery assembly including first and second walls spaced from one another in a cell stack direction to define a cell-receiving space therebetween. The battery assembly also includes a sidewall extending along a lateral side of the cell-receiving space, and a plurality of pouch cells stacked in the cell stack direction within the cell-receiving space. The battery assembly also includes a support plate having opposite lateral sides. One of the lateral sides is connected to the sidewall. The support plate extends transversely across the cell-receiving space between first and second pouch cells of the plurality of pouch cells to divide the plurality of pouch cells into first and second stacks of pouch cells. The pouch cells in each stack of pouch cells are retained against movement in a direction that is perpendicular to the cell stack direction by their compression between the support plate and the first or second wall.

### BACKGROUND

Batteries, such as those used in consumer devices, are typically formed of a plurality of battery cells (or just “cells”). Battery cells (such as lithium-ion cells) come in various formats. Known battery cells often have a cylindrical shape or a rectangular (or cuboid) shape. One type of rectangular battery cell that is increasingly being used in devices is a pouch cell. A pouch cell includes a laminated battery architecture contained within a flexible (i.e. non-rigid) pouch, which is commonly formed of a plastic coated, aluminium film.

Tabs are either provided at one end or two opposite ends of a pouch cell to provide terminals (i.e. one tab providing a negative terminal and the other providing a positive terminal) that allow electrical connection of the pouch cell to other pouch cells in a pouch cell stack or to the electrical components of a device. Pouch cells of the type that have terminals at opposite ends can, in some cases, be preferable because this typically provides better utilisation of the active area of the cell.

When pouch cells in a stack of pouch cells are of the type that include both terminals at the same end, the pouch cells are typically stacked in the same orientation, such that the positive terminal of each pouch cell can be connected to the negative terminal of an adjacent pouch cell (i.e. to electrically connected the pouch cells). In some arrangements, such pouch cells can be flipped (i.e. about an axis extending parallel to major faces of the pouch cells), which can better align the positive and negative terminals of each pouch cell with terminals of an opposite polarity of an adjacent pouch cell.

On the other hand, when pouch cells in a stack of pouch cells are of the type with terminals at opposite ends, each pouch cell is typically stacked in a reversed orientation to adjacent pouch cells, such that the positive terminal of the pouch cell is adjacent to the negative terminal of a neighbouring pouch cell in the stack (and likewise, such that the negative terminal of the pouch cell is adjacent to the positive terminal of another neighbouring pouch cell in the stack).

The use of a pouch rather than a rigid housing (as is the case with other types of battery cell) reduces the overall weight and volume of the cell. Likewise, the rectangular (or cuboid) shape provides a more efficient use of space than a cylindrical shape when multiple cells are packaged together. (i.e. in a cell stack). Typically, pouch cells are provided as a stack of pouch cells within an enclosure which helps to protect the pouch cells (which are particularly susceptible to damage to their flexible pouches).

### SUMMARY

In a first aspect, there is disclosed a battery assembly comprising:
first and second walls spaced from one another in a cell stack direction so as to define a cell-receiving space therebetween;
a sidewall extending along a lateral side of the cell-receiving space;
a plurality of pouch cells stacked in the cell stack direction within the cell-receiving space,
a support plate having opposite lateral sides, one of the lateral sides connected to the sidewall, the support plate extending transversely across the cell-receiving space between first and second pouch cells of the plurality of pouch cells so as to divide the plurality of pouch cells into:
   a first stack of pouch cells that is compressed between the support plate and the first wall; and
   a second stack of pouch cells that is compressed between the support plate and the second wall
wherein the pouch cells in each stack of pouch cells are retained against movement in a direction perpendicular (i.e. substantially perpendicular) to the cell stack direction by their compression between the support plate and the first or second wall.

The provision of the support plate can aid in the restriction of movement of pouch cells in pouch cell stack, especially for example when a shock is applied to the battery assembly which would otherwise cause such movement (e.g. as a result of the battery assembly, or an appliance in which the battery assembly is installed, being dropped).

It can be desirable to provide a battery assembly with a plurality of pouch cells that are stacked on top of one another. The pouch cells can be in direct contact or in indirect contact (e.g. via a layer of foam and/or adhesive). Stacking pouch cells in this way can be relatively space-efficient (i.e. providing high energy density).

While such stacking can achieve space-efficiency, however, it can also mean that less support is provided to the pouch cells. As a result, the pouch cells may be susceptible to movement in a direction that is perpendicular to the cell stack direction (i.e. in a shear direction), especially under a shock loading. Pouch cells in the centre of a stack of cells can be particularly susceptible to such movement because, unlike those at either end of the stack, intermediate cells are supported only by their contact with other cells (which may exhibit some movement themselves under shock).

In the first aspect, the provision of the support plate, which is connected to the sidewall, within the stack of pouch cells helps to reduce this movement. The support plate does so by supporting a pair of intermediate cells against movement in the shear direction.

Optional features of the first aspect will now be set out. These are applicable singly or in any combination with any aspect.

At least one of (e.g. each) of the first and second walls may have opposite (e.g. substantially parallel) lateral sides connected by opposite (e.g. substantially parallel) first and second ends.

The lateral sides of the support plate may be connected by opposite (e.g. substantially parallel) first and second ends. The support plate may be substantially rectangular. The support plate may be an integrally formed, unitary piece. The support plate may be substantially planar. The support plate may have opposite major faces (e.g. upper and lower faces). One or both of the opposite major faces may be substantially planar.

The cell-receiving space may, likewise, include opposite (e.g. parallel) lateral sides that are connected by (e.g. parallel) opposite ends. The cell-receiving space may have a substantially cuboid shape.

In at least one orientation the first and second walls may be upper and lower walls of the battery assembly (in which case the cell stack direction may be substantially vertical). In such an orientation each of the first and second walls and the support plate may extend substantially horizontally. The sidewall may extend substantially vertically (e.g. between the first and second walls). It should be appreciated, though, that the battery assembly may be used in any orientation. The sidewall may connect the first and second walls.

The connection of the support plate with the sidewall may be configured such that the support plate is moveable in the cell stack direction relative to the sidewall. Pouch cells can expand and contract in use (i.e. in the cell stack direction), for example over charge/discharge cycles. Allowing movement of the support plate in the cell stack direction may allow the support plate to accommodate this expansion and contraction of the pouch cells in use (i.e. the support plate may be moved in the cell stack direction as a result of such expansion and contraction).

The connection of the support plate with the sidewall may be configured to restrict movement of the support plate in a direction parallel to the lateral sides of the support plate (e.g. in a direction along the sidewall). The connection of the support plate with the sidewall may be configured to restrict movement of the support plate in a direction extending between the ends of the support plate.

The connection (between the support plate and the sidewall) may comprise a protrusion received in a recess (e.g. aperture or slot). In other words, one of the sidewall and the support plate may comprise a protrusion and the other of the sidewall and the support plate may comprise a slot and the protrusion may be received in the slot to provide the connection between the support plate and the sidewall.

The protrusion may be in the form of a tab. The tab may extend from the lateral side of the support plate (i.e. the lateral side that is connected to the sidewall). In such embodiments, the recess may be formed in the sidewall (for example, may be a slot or aperture formed in the sidewall).

A width of the protrusions (e.g. tab) may be substantially the same as a width of the recess (the width being taken in a direction that is substantially parallel to the lateral side of the support plate). In this way, relative movement between the recess and the protrusion may be restricted in a direction along the lateral side of the support plate.

A height of the protrusion may be less than a height of the recess (the height being taken in the cell stack direction). Thus, there may be a clearance between the periphery of the recess and the protrusion in the cell stack direction. Accordingly, the protrusion may be substantially free to move relative to the recess in the cell stack direction.

The sidewall may be a first sidewall and the battery assembly may comprise a second sidewall. The first and second sidewalls may extend along opposite lateral sides of the cell-receiving space. Each lateral side of the support plate may be connected to a respective one of the sidewalls. In this way, the support plate may span the sidewalls. The connection of the support plate to the second sidewall may be as described above with respect to the first sidewall.

Each pouch cell may comprise opposite major faces. The support plate may be in contact with substantially the entirety of a respective major face of each of the first and second pouch cells. In this way, a substantially constant pressure may be applied (by the support plate) to the first and second pouch cells across their respective major faces.

The battery assembly may comprise a biasing arrangement. The biasing arrangement may, for example, comprise resilient layers provided between two or more of the pouch cells and/or between at least one pouch cells and one of the first and second walls. Each resilient layer may be e.g. a foam layer.

In some embodiments, the biasing arrangement may comprise a spring member connecting the first and second walls and configured to urge the first and second walls towards one another. The spring member may have a first end connected to the first wall and a second end connected to the second wall. The spring member may be configured to flex between an expanded position and a contracted position (in which the first and second ends of the spring member are closer together than in the expanded position). The spring member may be biased towards the contracted position.

The sidewall may, for example, be the spring member. The sidewall may comprise a body and first and second arms extending from the body and that respectively engage the first and second walls. The body and/or arms may be configured to flex between an expanded position and a contracted position (in which the arms are closer together than in the expanded position).

The support plate may comprise first and second contact regions respectively in contact with the first and second pouch cells (i.e. in contact with respective major faces of the first and second pouch cells). For the avoidance of doubt, in some embodiments each contact region may be in indirect contact with the pouch cells via e.g. an adhesive or other layer which has minimal effect on heat transfer between the pouch cell and the contact region. In this respect, each contact region may be referred to as a “thermal” contact region (i.e. for thermal contact with a respective pouch cell). In other embodiments, each contact region (or at least one contact region) may be in direct contact with a respective pouch cell (i.e. with no intervening layers provided therebetween).

Each contact region may be substantially planar (i.e. to provide even pressure distribution to the pouch cells). The support plate may comprise an external region that is not in contact with the pouch cells (the external region may be an exposed area of the support plate).

The battery assembly may comprise a temperature sensor (e.g. a thermistor) in contact with the external region to measure the temperature of the support plate at the external region.

In this way, the support plate may provide dual functionality. Firstly, as discussed above, it may provide support to the pouch cells in the shear direction (i.e. so as to restrict movement of the support cells). Secondly, as is described in further detail below, the support plate may provide a thermal pathway for effective temperature measurement of the pouch cells.

In operation of a battery assembly, it can be desirable to measure the temperature at the hottest part of a pouch cell stack, for example, to ensure that the pouch cells are operating correctly, to avoid overheating (which could result in a thermal runaway event), and to minimise degradation of the pouch cells. Typically, the highest temperature will occur at approximately the centre of a cell stack. For pouch cells with terminals at opposite ends the highest temperature will typically be at approximately the centre of the central pouch cell in the cell stack. For pouch cells with both terminals at the same end, the highest temperature is offset from centre towards the terminals.

The closest accessible point to these regions (at which temperature can be measured) is typically between two pouch cells. However, introducing a temperature sensor between two pouch cells is undesirable, because doing so disturbs the uniformity of the pressure applied to the pouch cells (and also necessarily increases the height of the assembly in the cell stack direction). Likewise, positioning a temperature at a periphery of a pouch cell (e.g. on a terminal) is undesirable because, due to the nature of the internal contents of a pouch cell, there can be a significant difference between the temperature at the periphery of a cell and at the centre of the cell.

By using the support plate to provide a thermal pathway, the sensor can be placed externally of the pouch cells (to maintain pressure uniformity and minimise height in the cell stack direction). Likewise, unlike the pouch cell itself, a support plate can be configured to provide an effective thermal pathway. That is, the support plate can be configured to ensure that there is a minimal temperature difference between the centre of the first and second pouch cells (either side of the support plate) and the portion of the support plate that is sensed by the sensor.

To minimise any offset in temperature from the centre of the cell stack, the support plate may, for example, be formed of a material having high thermal conductivity, such as copper or aluminium.

The support plate may have a thickness of less than 0.5 mm. The support plate may have a thickness that is less than 0.4 mm. In some embodiments, the thickness of the support plate may be less than 0.2 mm.

The external region of the support plate may be at least partly provided by a temperature sensing tab extending from the contact region. The sensor may be mounted to the temperature sensing tab. The temperature sensing tab may be provided at (or proximate to) a corner of the support plate. In some embodiments, the temperature sensing tab may be a first temperature sensing tab and the support plate may comprise a second temperature sensing tab (a second temperature sensor may be mounted thereon). The first and second temperature sensing tabs may be provided, for example, at opposite ends of the support plate (e.g. opposite corners).

In some embodiments, the support plate may be electrically conductive (e.g. may be configured to conduct electricity). As will be described below, this may again provide the support plate with additional functionality (i.e. in combination with the pouch cell supporting function and optionally the thermal pathway function discussed above). This is because the support plate may be utilised to provide a pathway for electricity to flow from one pouch cell to another (e.g. from the first pouch cell to the second pouch cell).

Each pouch cell may comprise a first end having a positive terminal and a second end having a negative terminal. Each pouch cell may be arranged so as to be reversed in orientation (i.e. rotated 180 degrees about an axis extending in the cell-stack direction) to at least one adjacent pouch cell. In other words, each pouch cell may be arranged such that a terminal of the pouch cell is adjacent to a terminal of opposite polarity of a neighbouring pouch cell (in the stack). Thus, at least one terminal of each pouch cell may be in electrical contact with a terminal of opposite polarity of a neighbouring pouch cell in the stack of pouch cells.

A first end of the support plate may be in electrical contact with the positive terminal of the first pouch cell and a second, opposite, end of the support plate may be in electrical contact with the negative terminal of the second pouch cell so as to provide an electrical connection between the first and second pouch cells.

The plurality of pouch cells may consist of an odd number of pouch cells. Providing an electrically conducting support plate may be particularly useful in a battery assembly comprising an odd number of pouch cells (in which each pouch cell has terminals at opposite ends). As has been discussed above, in a pouch cell stack where the pouch cells have terminals at opposite ends, to connect the pouch cells directly to one another they must typically be stacked so as to have alternating orientation. In effect, this forms an electrical pathway that zig-zags along the stack of pouch cells. When there is an odd number of cells, the “open” terminals of the uppermost and lowermost cells of the stack (i.e. those that provide for connection to the electrical circuitry of an appliance) will be at opposite ends of the stack. In some cases, for example, where the electrical circuitry of the appliance is located at one end of the battery assembly, this can be undesirable. For example, it can require the addition of wiring that provides a pathway for current from one end of the cell stack to the other.

Using the support plate as an electrical pathway, when there is an odd number of pouch cells in the stack can ensure that both open terminals are at the same end of the pouch cell stack. In effect, the support plate acts as a proxy bus bar (or pouch cell) so that the first and second pouch cells adjacent the support plate have the same orientation. This results in the open terminals being at the same end of the stack of pouch cells (i.e. in the same way as would be the case with an even number of pouch cells in the stack).

As may be appreciated, the use of the support plate in this way provides the battery assembly with versatility. When the battery assembly includes an even number of pouch cells, electrical connection to the support plate can be omitted (i.e. the first and second pouch cells either side of the support plate can simply electrically connect to one another, bypassing the support plate). When the battery assembly includes an odd number of pouch cells, the support plate can be electrically connected with the pouch cells (as described above).

At least one of the first and second stacks of pouch cells may comprise at least three pouch cells.

In a second aspect, there is provided a battery assembly comprising:
first and second walls spaced from one another in a cell stack direction so as to define a cell-receiving space therebetween;
a plurality of pouch cells stacked in the cell stack direction within the cell-receiving space, each pouch cell comprising positive and negative terminals provided at opposite ends of the pouch cell;
an electrically conductive support plate extending across the cell-receiving space between first and second pouch cells of the plurality of pouch cells, wherein a first end of the support plate is in electrical contact with the positive terminal of the first pouch cell and a second opposite end of the support plate is in electrical contact with the negative terminal of the second pouch cell, such that the support plate provides an electrical pathway electrically connecting the first and second pouch cells.

As has been described above, providing a support plate that provides an electrical pathway in this manner can ensure that the two “open” terminals of the stack of pouch cells are both at the same end of the stack of pouch cells.

Optional features of the second aspect will now be set out. These are applicable singly or in any combination with any aspect.

The pouch cells may be arranged such that at least one terminal of each pouch cell is in electrical contact with a terminal of opposite polarity of a neighbouring pouch cell in the stack of pouch cells.

The battery assembly may comprise a sidewall extending along a lateral side of the cell-receiving space. The support plate may have opposite lateral sides. One of the lateral sides may be connected to the sidewall.

The battery assembly of the second aspect may be as otherwise as described above with respect to the first aspect. The battery assembly of the second aspect may include one or more of the optional features described above with respect to the first aspect.

In a third aspect, there is provided an appliance comprising the battery assembly according to the first or second aspect. The appliance may be a vacuum cleaner.

### BRIEF DESCRIPTION OF THE DRAWINGS

FIG. 1A is a perspective view of a battery assembly;

FIG. 1B is a front section view of the battery assembly of FIG. 1A;

FIG. 1C is a side section view of the battery assembly of FIG. 1A;

FIG. 2 is a top view of a support plate of the battery assembly of FIG. 1A;

FIG. 3 is a perspective view of a sidewall of the battery assembly of FIG. 1A, and

FIGS. 4A and 4B are respectively section views of a battery assembly without a support plate under shock loading and a battery assembly with a support plate under shock loading.

### DETAILED DESCRIPTION

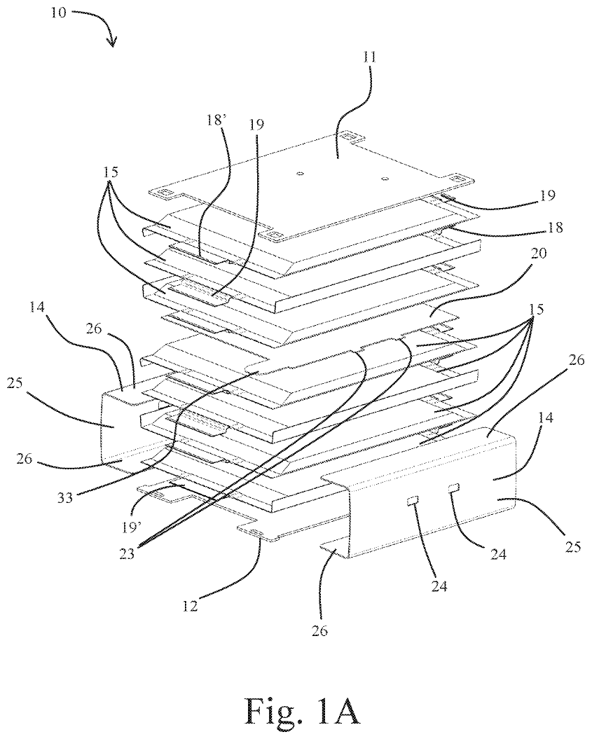

FIGS. 1A, 1B and 1C illustrate a battery assembly 10 that includes first 11 (upper) and second 12 (lower) planar walls spaced from one another in a cell stack direction (vertical as illustrated) so as to define a cell-receiving space 13 therebetween. The battery assembly 10 also includes two opposite, substantially vertical, sidewalls 14 that each extend along a respective lateral side of the cell-receiving space 13. The battery assembly 10 thus includes opposite lateral sides 29 defined by the sidewalls and opposite ends 30 (which are open in the illustrated embodiment).

Seven pouch cells 15 are stacked in the cell stack direction within the cell-receiving space 13. Each pouch cell 15 has opposite (in this case upper and lower) major faces 16 that face the first 11 and second 12 walls. The pouch cells 15 are stacked so that their major faces 16 are in contact with one another (although it should be appreciated that such further layers could be provided between the pouch cells 15, such as adhesive or foam layers).

Each pouch cell 15 includes a positive terminal 18 and a negative terminal 19 (only some of which are labelled for clarity), which are provided at opposite ends of the pouch cell 15. These allow electrical connection of each pouch cell 15 to other pouch cells 15 in the stack (and to the electrical circuitry of an appliance in which the battery assembly 10 may be provided).

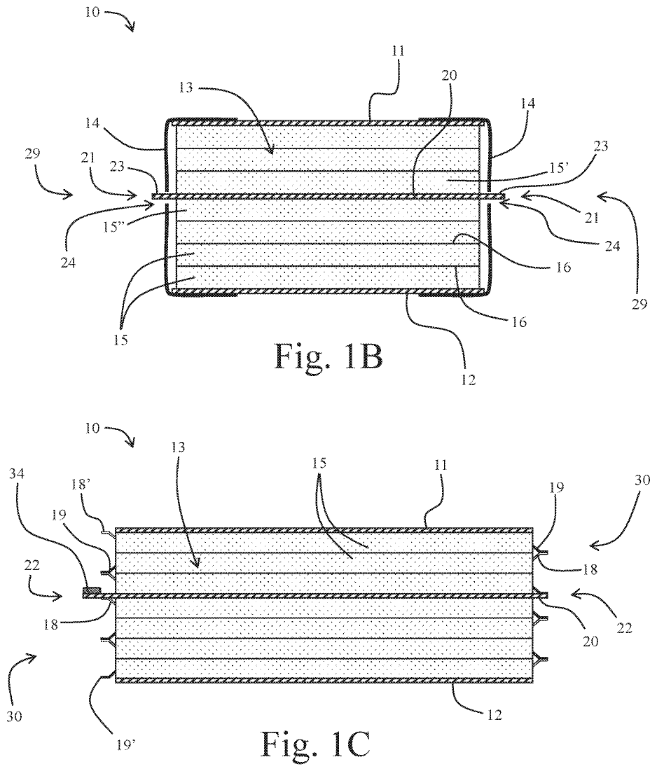

The battery assembly 10 also includes a planar support plate 20 which extends transversely across the cell-receiving space 13 so as to be sandwiched between first 15′ and second 15″ pouch cells of the plurality of pouch cells 15 (and so as to divide the pouch cells 15 into a first sub-stack of three pouch cells 15 and second sub-stack of four pouch cells 15). The support plate 20, which is also shown in FIG. 2, is substantially rectangular and includes opposite lateral sides 21 that are connected by opposite ends 22. Each lateral side 21 of the support plate 20 is connected to a respective sidewall 14. To provide these connections, each lateral side 21 of the support plate 20 includes two protrusions in the form of tabs 23 (that project outwardly from the respective lateral side 21). Each tab 23 is received in a respective recess, in the form of a slot 24, formed in the respective sidewall 14. As may be appreciated, in other embodiments tabs (or a single tab) may be only provided on one side of the support plate 20 and slots 24 (or a slot) may be provided in only one of the sidewalls 14, such that the support plate 20 is only connected to one of the sidewalls 14.

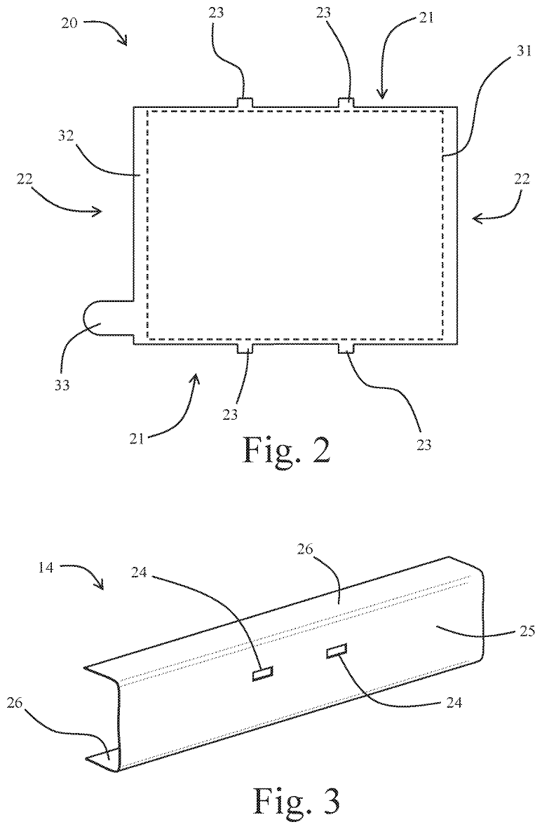

The slots 24 are best shown in FIG. 3, which depicts one of the sidewalls 14 (it should be appreciated that the other of the sidewalls is a mirror image of the illustrated sidewall 14). Each tab 23 has a width (horizontal dimension in FIG. 2) that is the same as the width of the slot 24 in which it is received. This restricts relative movement of the support plate 20 and sidewalls 14 in a direction that is parallel to the lateral sides 21 of the support plate 20 (i.e. into and out of the page in FIG. 1B).

On the other hand, each tab 23 has a height (which is the same as the thickness of the support plate 20) that is smaller than a height of the slot 24 into which the tab 23 is received. This means that relative movement of the support plate 20 and the sidewalls 14 in the cell stack direction is permitted. In practice, this allows the support plate 20 to move in the cell stack direction as the pouch cells 15 expand and contract in use.

In the illustrated embodiment, the pouch cells 15 are retained in the cell-receiving space 13 by compression between the support plate 20 and the first 11 and second 12 walls. To maintain such compression, the sidewalls 14 are configured to urge the first 11 and second 12 walls towards one another.

Each sidewall 14 comprises a body 25 and two arms 26 that extend transversely from the body 25 such that each of the arms engages one of the first 11 and second 12 walls. The arms 26 and body 25 of each sidewall are configured to flex such that the sidewall 14 can move between a contracted configuration (in which the arms 26 are closer together) and an expanded configuration (in which the arms 26 are further apart), as shown in FIG. 3. Each sidewall 14 is formed of a resilient material (e.g. steel) and is biased towards the contracted configuration, which urges the first 11 and second 12 walls towards one another (i.e. the sidewalls providing a biasing arrangement for biasing the walls 11, 12 together).

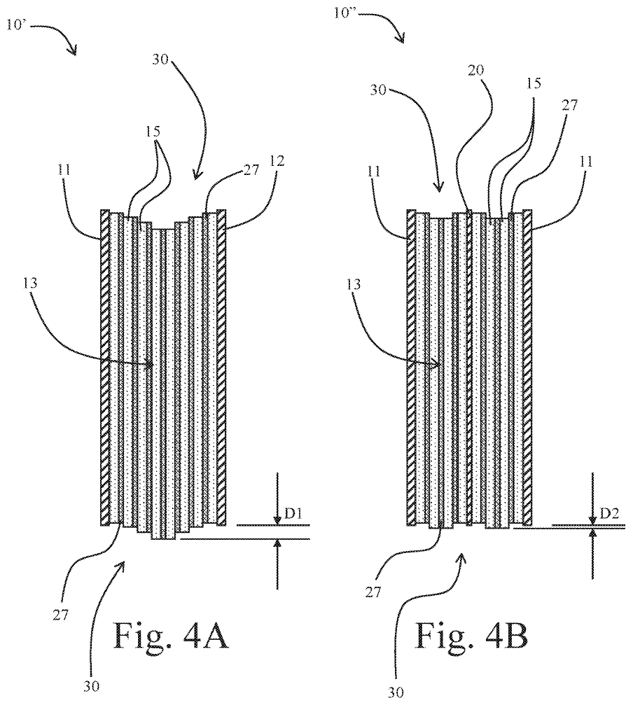

While retaining the pouch cells 15 in this way can be space efficient, in some scenarios (such as under shock loading) the pouch cells 15 can be susceptible to movement. As is illustrated by FIGS. 4A and 4B, the support plate 20 helps to reduce such movement.

Each of these figures illustrates a battery assembly 10′ and 10″ including first 11 and second 12 walls defining a cell-receiving space 13 therebetween. A plurality of pouch cells 15 are stacked in each cell-receiving space and a plurality of foam layers 27 are provided between the pouch cells 15 (in this case, the foam layers 27 aid in compressing the pouch cells 15 between the walls 11, 12). The battery assembly 10″ of FIG. 4B further includes a support plate 20 (i.e. like that previously described) extending across the cell-receiving space 13 so as to be sandwiched between two pouch cells 15. No support plate is present between the pouch cells 15 of the battery assembly 10′ of FIG. 4A.

Both figures illustrate the result of the application of a shock load in a direction between ends 30 of each battery assembly 10′, 10″ (i.e. in a vertically downward direction as illustrated). As should be apparent from a comparison of FIGS. 4A and 4B, the of the support plate 20 (which is fixed to sidewalls that are not shown) does not move, or at least has limited movement, and thus reduces the overall movement of the pouch cells 15 in the direction of the load (this should be apparent from a comparison of the overall movement distance D1 of the pouch cells 15 of FIG. 4A when compared to the overall movement distance D2 of the pouch cells 15 of FIG. 4B.

The support plate 20, which may be (e.g. aluminium or copper) also provides both thermal and electrical functions.

Returning to FIGS. 1A, 1B, 1C and 2, it should be apparent that the support plate 20 is in contact with substantially the entirety of respective major faces of the first 15′ and second 15″ pouch cells. The regions of the support plate 20 that are in contact with the pouch cells 15′, 15″ are referred to herein as contact regions 31 (one such region is depicted by dashed lines in FIG. 2). Each contact region 31 is substantially planar and smooth to ensure an even pressure distribution applied to the pouch cells 15′, 15″.

The support plate 20 also includes regions that are not in contact with the pouch cells 15′, 15″. These regions are referred to herein as external regions 32 (i.e. on provided on each side of the support plate 20). A part of each external region 32 is defined by a temperature sensing tab 33 which projects at an end 22 of the support plate 20. As is apparent from FIG. 1B, a temperature sensor 34 (not shown in FIG. 1A) in the form of a thermistor is mounted to the temperature sensing tab 33 so as to be able to measure the temperature of the temperature sensing tab 33. As may be appreciated, in other embodiments, one or more additional tabs may be provided (with one or more additional temperature sensors mounted thereto).

In this way, the support plate 20 provides a thermal pathway from a location that is close to the centre of each of the first 15′ and second 15″ pouch cells (which would typically represent the hottest part of the battery assembly 10 in use) to the sensor 34. The support plate 20, which is formed of aluminium and is about 0.3 mm thick, provides low thermal resistance so as to ensure that there is minimal difference between the temperatures at the respective centres of the first 15′ and second 15″ pouch cells and at the sensor 34. This avoids the need to position a sensor between the pouch cells 15′, 15″ (which could disrupt the uniform pressure distribution on the pouch cells 15′, 15″). The support plate 30, because of its low thermal resistance, also provides a better thermal pathway than through one of the pouch cells 15′, 15″. Hence, the provision of the sensor 34 on the support plate 30 results in a smaller thermal offset than would be the case, for example, if the sensor was provided on an end of a pouch cell 15.

The support plate 20 also provides an electrical pathway. As mentioned above, each pouch cell 15 includes a positive terminal 18 and a negative terminal 19 which are provided at opposite ends of the pouch cell 15. Each pouch cell 15 is arranged such that at least one of its terminals 18, 19 is in electrical contact with a terminal 18, 19 of opposite polarity of a neighbouring pouch cell 15. In other words, for all pouch cells 15 except the uppermost and lowermost pouch cells 15 in the stack, the positive terminal 18 of the pouch cell 15 is in electrical contact with a negative terminal 19 of a neighbouring pouch cell 15 and the negative terminal 19 is in electrical contact with a positive terminal 18 of another neighbouring pouch cell 15. This arrangement is achieved by alternating the orientation of the pouch cells 15 (i.e. moving along the stack) so that each pouch cell 15 has a reverse orientation to one or more neighbouring pouch cells 15 (i.e. rotated 180 degrees about an axis extending in the cell stack direction).

Connection of the pouch cells 15 in this way, of course, leaves one positive terminal 18′ and one negative terminal 19′ (which are terminals of the uppermost and lowermost pouch cells 15) that are not connected to another pouch cell 15. When assembled in an appliance, these terminals 18′, 19′ would electrically connect the battery assembly 10 to the appliance. These terminals 18′, 19′ are referred to as “open” terminals herein (because they do not connect to another terminal of the battery assembly 10).

The support plate 20 is electrically connected to the first 15′ and second 15″ pouch cells. In particular, one end 22 of the support plate 20 is in electrical contact with the negative terminal 19 of the first pouch cell 15′ and the other opposite end 22 of the support plate 20 is in electrical contact with the positive terminal 18 of the second pouch cell 15″. As a result, the first 15′ and second 15″ pouch cells have the same orientation (i.e. the positive terminals 18 of these pouch cells 15′, 15″ are adjacent one another and the negative terminals 19 of these pouch cells 15′. 15″ are also adjacent one another).

By using the support plate 20 to provide an electrical pathway in the manner described above, both open terminals 18′, 19′ are positioned at the same end 30 of the battery assembly 10. As should be appreciated, if the first 15′ and second 15″ were electrically connected to one another, rather than the support plate 20, the open terminals 18′, 19′ would be positioned at opposite ends 30 of the battery assembly 10.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A battery assembly comprising:
first and second walls spaced from one another in a cell stack direction so as to define a cell-receiving space therebetween;
a sidewall extending along a lateral side of the cell-receiving space;
a plurality of pouch cells stacked in the cell stack direction within the cell-receiving space; and
a support plate having opposite lateral sides, one of the lateral sides connected to the sidewall, the support plate extending transversely across the cell-receiving space between first and second pouch cells of the plurality of pouch cells so as to divide the plurality of pouch cells into:
a first stack of pouch cells that is compressed between the support plate and the first wall; and
a second stack of pouch cells that is compressed between the support plate and the second wall;
wherein the pouch cells in each or the first and second stack of pouch cells are retained against movement in a direction that is perpendicular to the cell stack direction by their compression between the support plate and the first or second wall.

2. The battery assembly to claim 1, wherein the connection of the support plate with the sidewall is configured such that the support plate is moveable in the cell stack direction relative to the sidewall.

3. The battery assembly according to claim 1, wherein the connection of the support plate with the sidewall is configured to restrict movement of the support plate in a direction parallel to the lateral sides of the support plate.

4. The battery assembly according to claim 1, wherein one of the sidewall and the support plate comprises a protrusion and the other of the sidewall and the support plate comprises a recess and the protrusion is received in the recess to provide the connection between the support plate and the sidewall.

5. The battery assembly according to claim 4, wherein the protrusion is a tab extending from the lateral side of the support plate connected to the sidewall and the recess is formed in the sidewall.

6. The battery assembly according to claim 1, wherein the sidewall is a first sidewall and the battery assembly comprises a second sidewall, the first and second sidewalls extending along opposite lateral sides of the cell-receiving space, and wherein each lateral side of the support plate is connected to a respective one of the sidewalls.

7. The battery assembly according to claim 1, wherein each pouch cell comprises opposite major faces, and wherein the support plate is in contact with substantially an entirety of a respective major face of each of the first stack and second stack of pouch cells.

8. The battery assembly according to claim 1, wherein the support plate comprises a contact region in contact with the first stack and second pouch cells and an external region that is not in contact with the pouch cells, and wherein the battery assembly comprises a temperature sensor in contact with the external region to measure the temperature of the support plate at the external region.

9. The battery assembly according to claim 8, wherein the external region is provided by a temperature sensing tab extending from the contact region.

10. The battery assembly according to claim 8, wherein the temperature sensor is a thermistor.

11. The battery assembly according to claim 1, wherein the support plate is electrically conductive.

12. The battery assembly according to claim 11, wherein each of the pouch cell in the first and second stack of pouch cells comprises a first end having a positive terminal and a second end having a negative terminal.

13. The battery assembly according to claim 12, wherein a first end of the support plate is in electrical contact with the positive terminal of the first stack of pouch cell and a second, opposite, end of the support plate is in electrical contact with the negative terminal of the second stack of pouch cell so as to provide an electrical connection between the first stack and second stack of pouch cells.

14. The battery assembly according to claim 1, where the plurality of pouch cells in the first stack and second stack of pouch cells consists of an odd number of pouch cells.

15. The battery assembly according to claim 1, wherein at least one of the first stack and second stack of pouch cells comprises at least three pouch cells.

16. The battery assembly according to claim 1, wherein the support plate has a thickness of less than 0.5 mm.

17. The battery assembly according to claim 1, wherein the support plate is formed of copper or aluminium.

18. A battery assembly comprising:
first and second walls spaced from one another in a cell stack direction so as to define a cell-receiving space therebetween;
a plurality of pouch cells stacked in the cell stack direction within the cell-receiving space, each pouch cell comprising positive and negative terminals provided at opposite ends of the pouch cell; and
an electrically conductive support plate extending across the cell-receiving space between a first set of pouch cells and a second set of pouch cells of the plurality of pouch cells, wherein a first end of the support plate is in electrical contact with the positive terminal of the first set of pouch cells and a second opposite end of the support plate is in electrical contact with the negative terminal of the second set of pouch cells, such that the support plate provides an electrical pathway electrically connecting the first and second pouch cells.

19. The battery assembly according to claim 18, where the plurality of pouch cells consists of an odd number of pouch cells.

20. The battery assembly according to claim 18, wherein the support plate is formed of copper or aluminium.
